(19) United States
(12) Patent Application Publication
(10) Pub. No.: US 2005/0268448 A1
(43) Pub. Date: Dec. 8, 2005

(54) Semi-automated door hinge pin removal tool

(76) Inventor: Grant Jones, Carlsbad, CA (US)

Correspondence Address: GARY APPEL, ESQ., 18301 IRVINE BOULEVARD, TUSTIN, CA, 92780, US

(21) Appl. No.: 10/859,322

(22) Filed: Jun. 3, 2004

(51) Int. Cl. E05D 11/06

(52) U.S. Cl. 29/270

(57) ABSTRACT

A semi-automated hinge pin removal tool comprises a pistol-shaped, housing main assembly member having a triggered base block subassembly including an acceptance barrel for receiving a door hinge assembly, a handle, and a trigger. A hinge pin head engaging assembly member is located at an open end of the acceptance barrel and includes a retaining positional ring subassembly, a pry blade head block subassembly, and a capture cap subassembly. The pry blade head block subassembly is mounted for axial movement from the acceptance barrel open end, and the pry blade head block subassembly is responsive to actuation of the drive trigger for extending from the acceptance barrel open end and is adapted to be forcibly inserted into a narrow gap intersection region formed between the sloped underside surface of a hinge pin head and the horizontal top surface of a hinge pin barrel enclosure. Operation of the drive trigger elevates the pry blade head relative to the acceptance barrel to thereby cause the hinge pin to be extracted from the hinge pin barrel enclosure.

### BACKGROUND OF THE INVENTION

1. Field of the Invention

The present invention relates generally to the field of hand tools, and more particularly to a semi-automated hand tool for the removal of a hinge pin from a door hinge assembly.

2. Background Discussion

Various inventions have been previously disclosed for hinge pin removal tools, and combination tools having a hinge pin removal feature. Many of the previous inventions that disclose a hinge pin removal apparatus are impractical and cause hinge or door damage, require undesirably strong impact concussion forces, or have insufficient leverage to first free, and then gradually and smoothly remove the hinge pin component with ease from its parent door hinge assembly.

The present invention provides a semi-automated hinge pin removal tool that has the capability to produce a very strong, sequentially increasing, mechanical force applied upward to the hinge pin head sloped undershoulder to effect the hinge pin extraction by the semi-automated door hinge pin removal tool having a housing main assembly member and a hinge pin head engaging assembly member comprising several cooperating subassemblies including a triggered base block subassembly, a cooperating pry blade head block subassembly, a retaining positional ring subassembly, a clamping top capture cap subassembly, and a power driving source. The housing main assembly member and the hinge pin head engaging assembly member component subassemblies together generate gripping and extracting mechanical forces that are much greater than that of previously ineffective hinge pin removal methods and devices.

Previous U.S. patents include U.S. Pat. Nos. 5,896,607; 6,256,855; 6,298,512; 6,351,881; and 6,684,471.

U.S. Pat. No. 5,896,607 discloses a multi-purpose hinge pin remover with a hand guard, which can be used as a pry bar. The multi-purpose hinge pin remover has a hand guard, a hammer head, and two additional working surfaces for repairing shingles.

U.S. Pat. No. 6,256,855 discloses a tool for removing a hinge pin from a door hinge assembly to facilitate the removal of doors. It comprises a pair of plier members, each with a jaw portion and a handle portion. The jaws of the plier member are made to fit around the shaft of a hinge pin where a force is applied in the removal of the hinge pin.

U.S. Pat. No. 6,298,512 discloses the same hinge pin remover tool, but with a hand guard as in U.S. Pat. No. 5,896,607. However, it has two new additions: a pry ridge added to the V-pry bar, and a threaded hole to receive a variety of work tools. This multi-purpose hinge pin and plastic clip remover comprises a bar shape with a claw having a V-shaped pry bar with a top surface designed to fit under a plastic cap.

U.S. Pat. No. 6,351,881 discloses a hinge pin removal tool with a head, a distal end, and a cylindrical stem portion. It comprises a bar portion with a first and second end portion. The first end portion has a flat tip with a concave curved edge used to insert between the head of a hinge pin and a hinge to wedge the hinge pin and hinge apart. The second end portion consists of a cylindrical projection used as a handle to displace the pin from the hinge plate.

U.S. Pat. No. 6,684,471 teaches a manual hinge pin removal tool, but as with its predecessors, does not perform the hinge pin extraction with ease of operation, and further, fails to apply sufficient force to smoothly and easily remove the hinge pin from its parent door hinge assembly.

These and other prior art U.S. patent inventions are commonly known to be ineffective and are hinge damage prone because they require the application of the brute force of a hammer impact in combination with a prying screwdriver or chisel applied to the front sloping undershoulder of the hinge pin head, or because they fail to apply sufficient mechanical force to smoothly and easily remove the hinge pin from its door hinge assembly.

### SUMMARY OF THE INVENTION

A semi-automated hinge pin removal tool having hinge pin removal features is disclosed comprising a housing main assembly member and a hinge pin head engaging assembly member containing several cooperative subassembly component members including (1) a triggered base block subassembly, (2) a moveable pry blade head block subassembly being movably activated by the triggered base block subassembly drive linkage arm rods to first initially move the pry blade head block subassembly horizontally forward, and then secondarily move the pry blade head block subassembly vertically upward in parallel relationship with the hinge pin barrel enclosure, top horizontal surface causing the pry blade head block subassembly front section blade face surface, that is pry-wedge edge shaped, to initially press against, then bite into, and thereafter press under the hinge pin head front sloping undershoulder held by the gripping and securing compressive contact combination of: (1) the triggered base block subassembly, acceptance barrel front face grooved recess; (2) the pry blade head block, front section blade face surface; (3) the beveled inner diameter of the retaining positional ring subassembly extending outward from the triggered base block subassembly engaging the back sloping undershoulder of the hinge pin head; and (4) the top capture cap subassembly retaining action upon the hinge pin head.

The triggered base block subassembly acts as a firm, pry base co-member and is structured with a frontal face acceptance barrel, semi-circular grooved recess, adapted for longitudinally accepting, containing, and exerting a firm base pressure on the horizontal top surface of the hinge pin barrel enclosure of the door hinge assembly, and further, contains a horizontally protruding, circular retaining positional ring mounted on the triggered housing base block, frontal face upper surface adapted to slip over, locate, and position for extraction the hinge pin head sloped undershoulder with respect to and in proper relationship with the horizontal, front section blade face surface of the hinge pin removal tool.

Housed within the triggered base block subassembly is a gear train having components comprising dual sister gears rigidly fixed co-axially to each other to operate in tandem, the first front spur gear being adapted for indexing by the trigger mechanism of the triggered base block subassembly, and the second rear pinion gear being adapted in gearing combination to drive the drive rack gear base bar vertically, reversibly up and down, along a longitudinal axis, so that when the sister gears rotationally move, the gear train drives its rack gear base member vertically upward, where it transmits a like parallel upward vertical force to the pry blade head block subassembly lower bottom surface to thereby also transmit a strong upward vertical force to the front section blade face surface that has been previously pre-positioned to slip and insert first against and then under the hinge pin front sloped undershoulder for moving and thus urging the hinge pin head vertically upward, thereby displacing and removing the hinge pin from its door hinge assembly. Forward activation of the front section blade face surface causes an associated clamping top capture cap front tang section to squeeze insert into the tapered narrow gap intersection region between the pin head sloped undershoulder and the retaining positional ring inwardly tapered, inside diameter surface to position fix the hinge pin removal tool, and to further secure the co-members comprising the hinge pin, triggered base block subassembly, retaining positional ring subassembly, and the clamping top capture cap subassembly together to cooperatively act, in unison, to smoothly and forcibly extract the hinge pin from its parent door hinge assembly.

An object of the present invention is to provide a semi-automated hinge pin removal tool with the smooth, constant, high, mechanical advantage force needed to efficiently, effectively, and thus simply remove the hinge pin from the door hinge assembly without damage to adjacent or nearby surfaces.

Another object of the present invention is to provide a semi-automated hinge pin removal tool that does not require the application of annoying, high concussion force, such as a hammer.

Another object of the present invention is to provide a semi-automated hinge pin removal tool employing the high mechanical advantage of a gear train to provide the strong leveraged force needed to easily and efficiently remove the hinge pin from the door hinge assembly.

Another object of the present invention is to provide a semi-automated hinge pin removal tool that is simple to use, effective in operation, and that can function with ease.

Another object of the present invention is to provide a semi-automated hinge pin removal tool that is practically noiseless.

Another object of the present invention is to provide a semi-automated hinge pin removal tool whereby the hinge pin does not pop explosively and become an airborne missile upon extraction.

### BRIEF DESCRIPTION OF THE DRAWINGS

The present invention can be more readily understood by a consideration of the following detailed description when taken in conjunction with the accompanying drawings, in which:

FIG. 1 illustrates a perspective view of the invention and the door hinge assembly.

FIG. 2 shows a top plan view of the hinge pin removal tool front section blade face surface.

FIGS. 3A and 3B show a left and a right hand view of the composite components of the hinge pin removal tool.

FIG. 4 shows an exploded view of the hinge pin removal tool components.

FIGS. 5A and 5B show a perspective view and a top view of the retaining positional ring subassembly.

FIG. 6 shows the front section blade face in operation.

FIGS. 7A, 7B, 7C each show a consecutive sequential, operational stage of the cooperating component, hinge pin removal positions of the front section blade face surface in combination with the retaining positional ring and the clamping top capture cap to fix the triggered base block in proper hinge pin extraction relationship and position.

FIG. 8 shows a cross-sectional view of the front section blade face surface in cooperative contact with the retaining positional ring and the top capture cap.

### DESCRIPTION OF THE PREFERRED EMBODIMENT

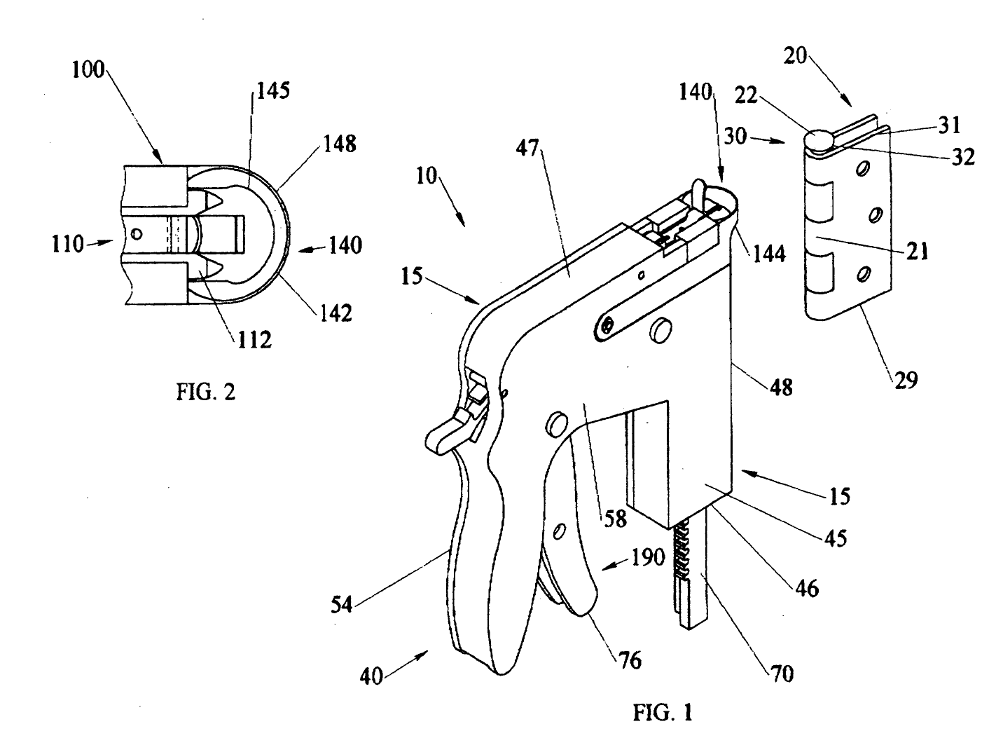

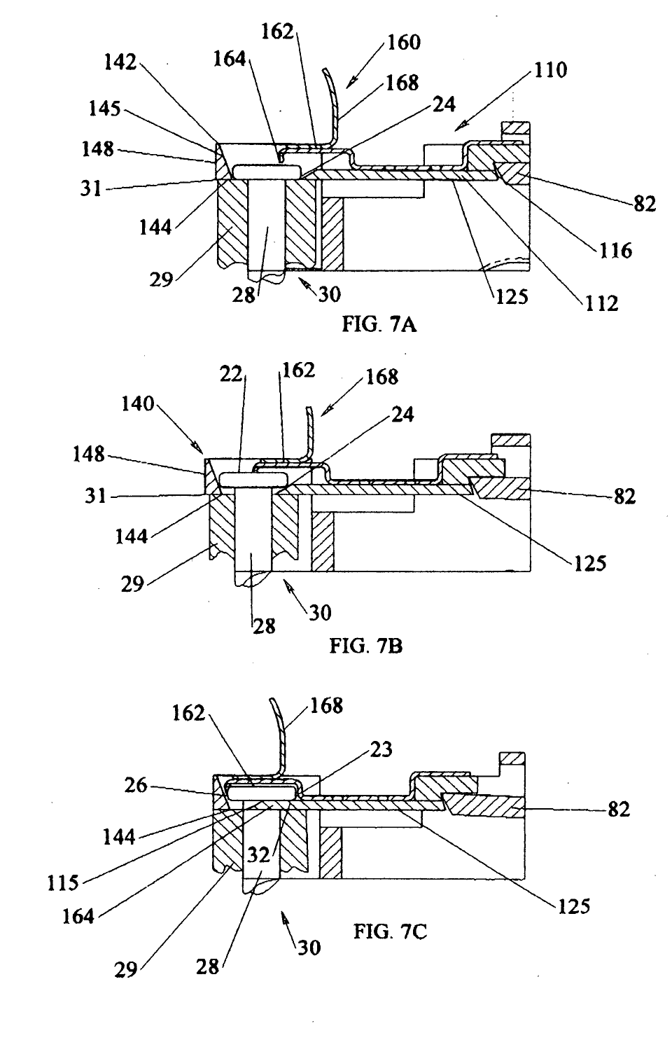

As shown in FIGS. 1-7, a semi-automated door hinge pin removal tool 10 has a pistol-shaped, housing main assembly member 15 and a hinge pin head engaging assembly member 100 for removing the hinge pin 30 from a hinge pin barrel enclosure 21. The pistol shaped, housing main assembly member 15 has a triggered base block subassembly 40 with an internal core cavity 44 adapted to hold and contain an internal gear train 60. The hinge pin head engaging assembly member 100 includes a pry blade head block subassembly 110 connected to the vertical upper top end 72 of the gear train ratchet means 60, a retaining positional ring subassembly 140 extension protruding horizontally outward and attached to the hinge acceptance barrel recess groove 52, frontal face surface 48 of the triggered base block subassembly 40 for positionally engaging and restraining the hinge pin back sloping undershoulder surface 26, and also adapted for positioning the semi-automated hinge pin removal tool in proper spaced relationship to the hinge pin barrel enclosure 21, and the semi-automated hinge pin removal tool trigger driving means 190, retractably connected to drive the gear train 60 comprising the rack drive pinion gear teeth 69 and the rack gear base bar teeth 76 when engaged, for moving the rack gear base bar 70 vertically upward in contact combination with the base undersurface 125 of the pry blade head block subassembly 110, front section blade face surface 112, and the clamping top capture cap subassembly 160 adapted for capturing and securing the top of the hinge pin head securely to the triggered base block subassembly 40, pry blade head block subassembly 110, and the retaining positional ring subassembly 140.

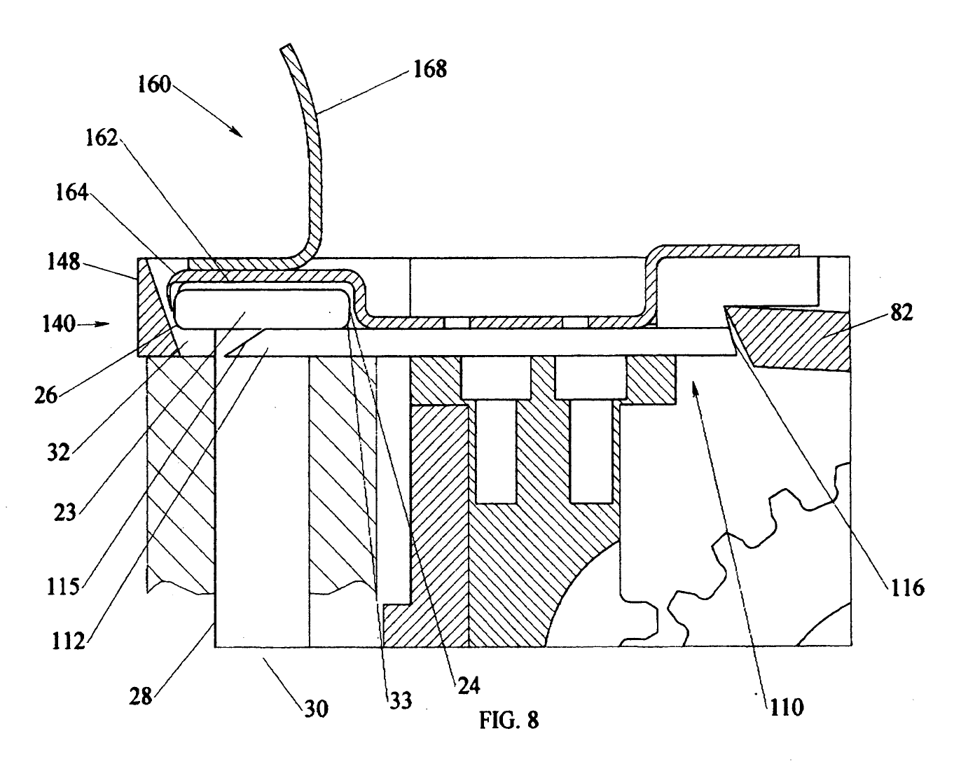

In FIGS. 1 and 8, the door hinge assembly 20 comprises a hinge pin 30, and a hinge pin barrel enclosure 21 for enclosing and retaining the hinge pin shaft 28 and flanges 29 for attachment to a door or similar object. The hinge pin 30 has a hinge pin circumferential undershoulder surface 23 with a front sloping undershoulder area 24, a back undershoulder area 26, and a hinge pin shaft 28. The hinge pin shaft 28 is generally concentrically inserted into and rotationally contained by the hinge pin barrel enclosure 21 in combination with the hinge pin flanges 29 to form the door hinge assembly 20 for typical swing door mounting. In a door hinge assembly, a narrow space gap intersection region 32 is normally formed, and thus present between the intersection of the hinge pin head sloped undershoulder surface 23 and the hinge pin barrel enclosure, horizontal top surface 31.

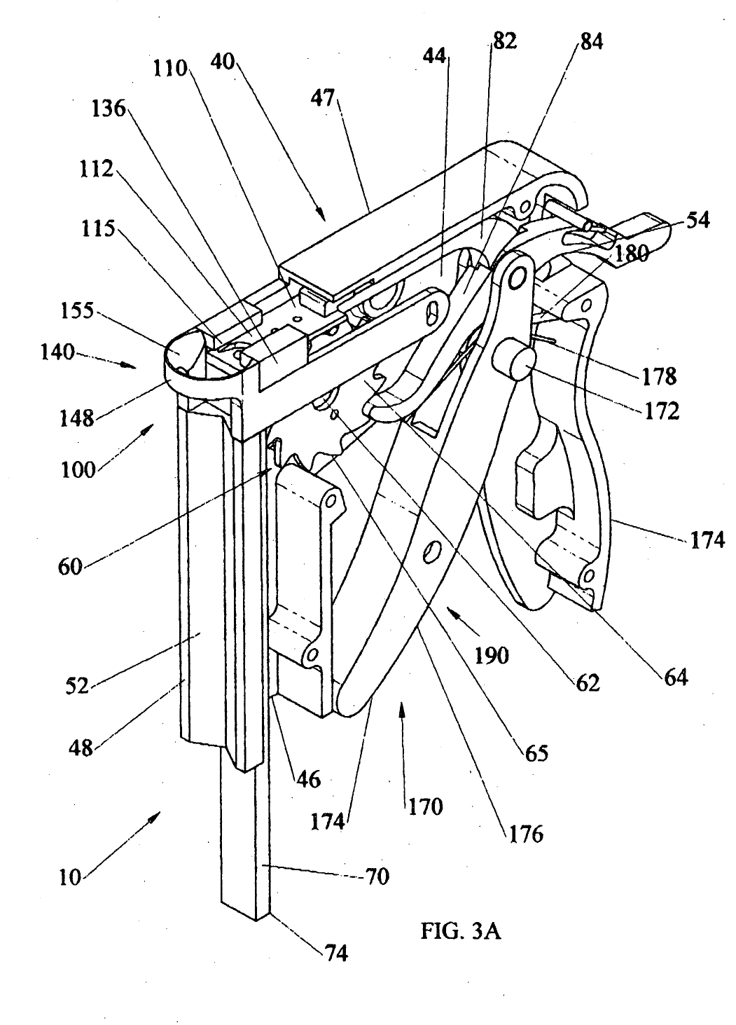

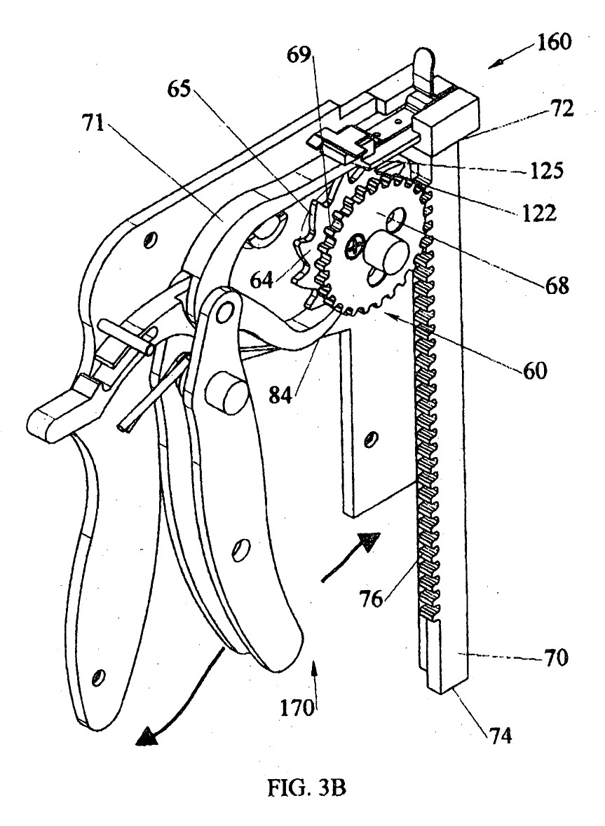

As shown in FIGS. 1, 3A and 3B, the triggered base block subassembly 40 has a frontal face 48, rear face 54, side faces 45, top face 47, and bottom face 46. A longitudinal vertical cavity is constructed from the top face 47 and extends centrally vertically downward between the housing top face 47 and bottom face 46, thereby forming an internal core cavity 44 to accommodate an internal gear train ratchet means 60. The triggered base block subassembly 40 accommodates the drive gear shaft 62 of the gear train 60, for securing and connecting trigger driving means 190 to drive arm rods 82 and 84 to move the drive gear shaft 62.

The frontal face surface 48 of the triggered housing block subassembly 40 is provided with a longitudinal, semi-circular, axially located, hinge acceptance barrel groove recess 52 extending vertically downward between the housing block top face surface 47, and bottom face surface 46, and is adapted to receive and constrain the hinge pin barrel enclosure 21 of the door hinge assembly 20, and to hold the hinge pin removal tool 10 in position to achieve vertical alignment and secure mating contact of the hinge pin removal tool 10 with the hinge pin barrel enclosure 21 of the door hinge assembly 20.

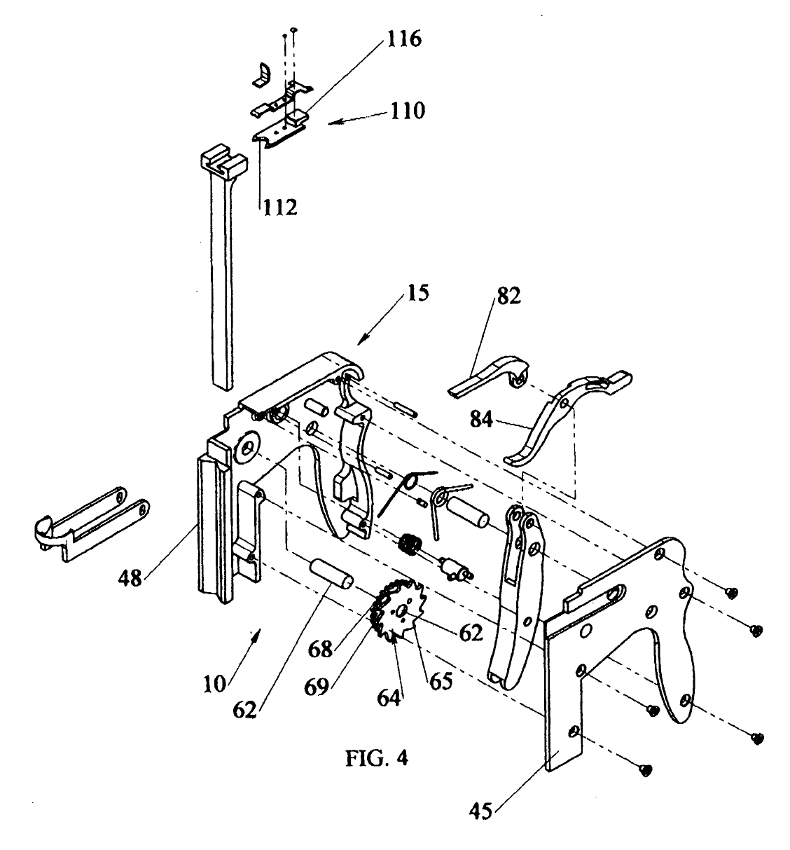

In FIGS. 3A, 3B, and 4, the gear train ratchet means 60 consists preferably of two drive gear members 64 and 68, spur gear 64 being first driven by rack gear drive advancing indexing arm rod 84, and then secondly by pinion driving gear 68 meshing with a vertically aligned, rack gear base bar member 70. Horizontal drive advancing rod arm 82 is adapted for end engagement with the pry blade head block, distal back section tail end surface 116 when activated by a spring-return, trigger driving means 190.

Slidably attached at the upper top end surface 72 of the vertical rack gear base bar 70 is the lower bottom surface of the pry blade head block subassembly 110. The rack gear base bar 70 stands vertically upward and parallel with the triggered base block subassembly 40, front face longitudinal acceptance barrel groove recess 52. The vertical upward movement of the rack gear base bar 70 causes the contacting surface of the pry blade head block subassembly 110 to first move the pry blade head block subassembly 110 slidingly horizontally forward, and then secondarily, cause the pry blade head block subassembly 110 to rise vertically upward in vertical contact with the upper top end 72 of the vertically positioned rack gear base bar 70.

As shown in FIGS. 4 and 6, the pry blade head block subassembly 110 has a proximal front section blade face 112 and a distal back section tail end 116, the proximal front section blade face surface 112 of the pry blade head block subassembly 110 is adapted to engage, insert and penetrate the space gap intersection region 32 formed between the hinge pin head front sloped undershoulder 24 and the hinge pin barrel enclosure, horizontal top surface 31.

In FIGS. 3A, 3B, 6, 7A, 7B, and 7C, the trigger driving means 190 includes a horizontally advancable trigger arm rod 82 adapted to first apply pressure to the distal back section tail end 116 of the pry blade head block subassembly 110 so as to forcibly, wedge engage the front section blade face surface 112 into the narrow space gap intersection region 32 formed between the hinge pin front sloping undershoulder 24 and the hinge pin barrel enclosure 21, horizontal top surface 31, and then in a secondary sequential action, apply additional force to the distal back section tail end 116, to force the proximal front section blade face surface 112 further into the narrow gap intersection region 32, squeezing, and thus displacing the hinge pin 30 vertically upward to extract the hinge pin shaft 28 from its hinge pin barrel enclosure 21.

The forward portion of the proximal front section blade face surface 112 is configured with a downward disc-beveled pry-wedge edge surface 115 to provide a wedged, leveraging force upward and against the hinge pin front undershoulder 24, thereby increasing prying force removal effectiveness. The pry block head block subassembly 110, distal tail section back end 116, when horizontally advanced, drives the proximal front section blade face surface 112, disc-beveled pry-wedge edge surface 115 further forward to deeply penetrate, then enlarge, and thus further widen the narrow space gap intersection region 32.

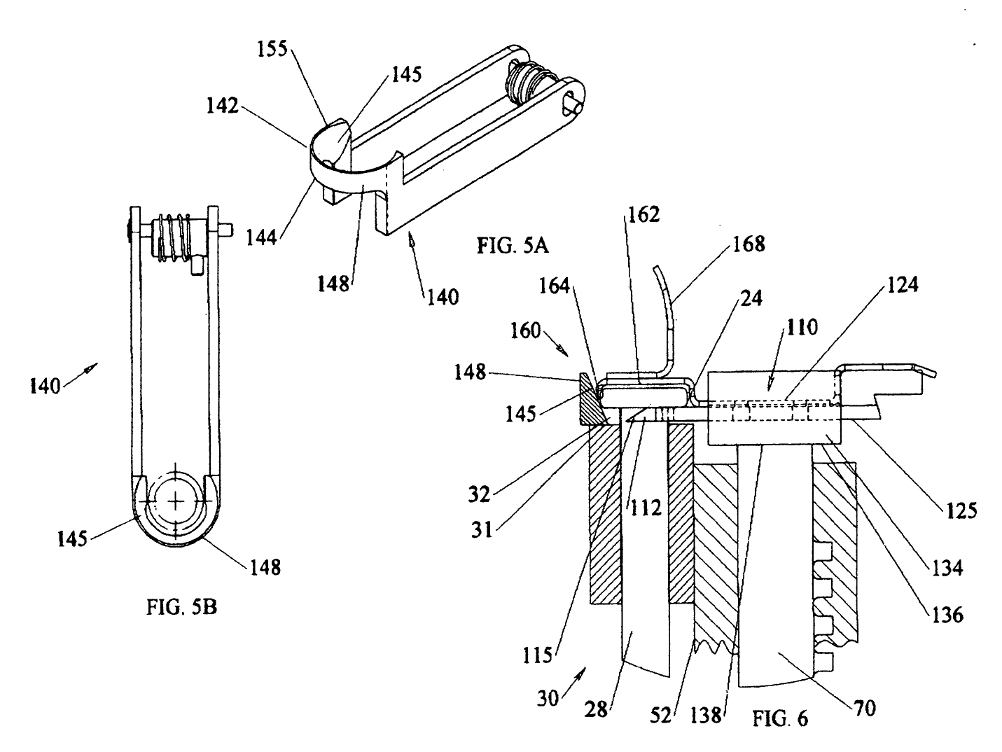

As shown in FIGS. 1, 5A and 5B, a horizontal, circular retaining positional ring subassembly 140, slightly larger in inner circumferential size than the hinge pin head circumferential sloped undershoulder 23, is provided and is attached to the triggered base block subassembly front top surface 47, where it protrudes horizontally outward and extends forward from the triggered base block subassembly 40, front surface 48 to first slip over, and then be moved downward to engage, position, retain, and secure the hinge pin back sloped undershoulder 26 against the hinge pin removal tool 10 penetrating movable proximal front section blade face surface 112, disc-beveled pry-wedge edge surface 115 of the pry blade head block subassembly 110. The ring internal diameter 155 of the retaining positional ring subassembly 140 may be bevel-edged 145 to facilitate and assist the hinge pin removal tool 10 positioning and contact prying engagement.

As shown in FIGS. 4, 5, and 6, the pry blade head block subassembly 110, and the horizontal retaining positional ring subassembly 140 are in parallel, opposing relationship with respect to each other, so that the disc-beveled pry-wedge edge surface 115 of the proximal front section blade face surface 112 prying action occurs at and in the narrow gap space intersection region 32 of the hinge pin front undershoulder 24 of the hinge pin head 22 and the hinge pin barrel enclosure, horizontal top surface 31 of the door hinge assembly 20, when the retaining positional ring subassembly 140 is slipped over to secure and hold retention contact with the hinge pin back undershoulder 26, while the prying disc-beveled pry-wedge edge surface 115 of the proximal front section blade face surface 112 of the pry blade head block subassembly 110 continues to penetrate and enlarge the hinge intersection region 32 of the door hinge assembly 20.

During the hinge pin extraction removal first stroke sequence, the proximal front section blade face surface 112 slides horizontally forward to engage the narrow gap space intersection region 32 of the door hinge assembly 20. Thereafter, during the hinge pin removal tool second stroke sequence, ratchet means internal gear train 60 is activated to provide sequentially a high mechanical force vertically upward in a direction parallel with respect to the longitudinal axis of the triggered base block subassembly 40, frontal face 48, hinge acceptance barrel groove recessed surface 52 to provide a partially enclosing firm prying base seat to contain and restrain the hinge pin barrel enclosure 31.

The pry blade head block subassembly 110 upper surface has attached thereto a top capture cap subassembly 160 for capturing the hinge pin head 22 by the clamp wedging action of the top capture cap subassembly 160 acting in combination with the retaining positional ring subassembly 140 so that all semi-automated hinge pin removal tool 10 components grip and assist in contributing to the vertically upward wedge prying action applied to the sloped undershoulder surface of the hinge pin head 22 to easily remove the hinge pin 30 from its hinge pin barrel enclosure 21.

In operation, as shown in FIGS. 1, 2, 3A, 3B and 7A, the triggered base block subassembly 40 and attached retaining positional ring subassembly 140 is first placed over the hinge pin head 22, so that the housing main assembly 15 is then firmly base supported, and the outer surface of the hinge pin barrel enclosure 21 properly rests and is retained in the front hinge acceptance barrel groove recess frontal surface 52 of the triggered base block subassembly 40 to thereby engage, press and maintain contact against the front surface of the hinge pin barrel enclosure 21 of the door hinge assembly 20. The outer top surface of the hinge pin barrel enclosure 21 acts as an additional firm base support for the door hinge pin removal tool 10, when the housing main assembly 15, retaining positional ring subassembly 140, fully engages the sloped under shoulder surface 26 of the hinge pin head 22, which is initially secured in the hinge pin barrel enclosure 21 of the door hinge assembly 20.

As shown in FIGS. 1, 3A, 6, 7A, 7B, and 7C, the horizontally and vertically movable pry blade head block subassembly 110, when slidingly moved horizontally forward by trigger mechanism driving means 190, moves the pry blade head block subassembly 110, proximal front section blade face surface 112, centrally forward to engage under and against the hinge pin front sloped undershoulder 24 of the door hinge assembly 20 and into the narrow gap space region 32 formed between the intersection of the hinge pin front undershoulder 24 and the hinge pin barrel enclosure horizontal top surface 31.

Additional application of force to the pry blade head subassembly, distal back section tail end 116, forces forward the proximal front section blade face surface 112, disc-beveled pry-wedge edge surface 115 against the hinge pin front sloped undershoulder 24 and the narrow gap space intersection region 32.

A trigger mechanism driving means 190 is then applied to the drive gear shaft 62, thereby indexing forward pinion gear 64, causing the rearward pinion gear drive teeth 69 to rotate, engaging and moving the mating rack gear base bar teeth 76 upward vertically. The rack gear base bar 70 then is forced vertically upward, parallel, and along the longitudinal axis of the triggered base block subassembly 40, where the high mechanical force advantage generated by the ratcheting means internal gear train 60, causes the connected horizontal pry blade head block subassembly 110, front section blade face surface 112, disc-beveled pry-wedge edge surface 115, to more fully engage and penetrate the sloped front undershoulder 24 of the hinge pin head 22, while the retaining positional ring subassembly 140 holds the hinge pin head 22 against the proximal front section blade face surface 112 disc-beveled pry-wedge edge surface 115, to aid in the prying vertical, upward movement being applied by the front section blade face surface to mechanically displace and extract the hinge pin shaft 28 from the hinge pin barrel enclosure 21.

When the trigger mechanism driving means 190 is activated by applying a rotational force to the drive gear shaft 62 through a first sister spur gear 64, the rear second sister pinion gear drive teeth 69 of the ratcheting means gear train 60 engages the rack gear teeth 69 of its mating rack pinion gear 68 to transmit a high mechanical advantage vertical force along the mating rack gear base bar 70 to thereby force the displacement of the gear rack base bar 70 vertically upward through rack gear base upper top end 72 connection linkage, to transmit a like force to the pry blade head block subassembly 110, and the front proximal section blade face surface 112, disc-beveled pry-wedge edge surface 115, and then along the line of interference narrow gap contact intersection region 32 between the front undershoulder sloped surface 24 of the hinge pin head 22 and the hinge pin barrel enclosure 21 horizontal top surface 31, thus forcing the hinge pin head 22 to move upward along its longitudinal vertical axis in vertical relationship with the longitudinal axis of the horizontal proximal front section blade face surface 112, disc-beveled pry-wedge edge surface 115.

The pry blade head block subassembly 110 vertical force movement is transmitted by means of contact alignment with the vertical upper top end 72 of the rack gear base bar 70, and the slideable horizontal pry blade head subassembly 110, having a proximal front section blade face surface 112 shaped as a disc-beveled pry-wedge edge surface 115 extending outward and horizontally perpendicular to the triggered base block subassembly 40. Upon activation, the disc-beveled pry-wedge edge surface 115, of the front section blade face surface 112, thus extends horizontally outward from the pry blade head block subassembly 110, proximal front section blade face 112, to press the disc-beveled pry-wedge edge surface 115 into, engage, and penetrate the narrow gap intersection region 32 formed between the hinge pin sloped front undershoulder 24 and the hinge pin barrel enclosure 21, horizontal top surface 31 to leverage upward to thereby force the hinge pin head 22 from its hinge pin barrel enclosure 21.

The triggered base block subassembly 40 has a protruding circular, internal diameter beveled, retaining positional ring subassembly 140 extending horizontally forward from the triggered base block subassembly 40, frontal face surface 48, hinge acceptance barrel groove recess 52 adapted to slip between the back sloped undershoulder 26 of the hinge pin head 22 and the back sloping surface of the internal diameter 155 of the retainer positional ring subassembly 140 to position and hold the triggered base block subassembly 40, front face hinge acceptance barrel groove recessed surface 52 against the exterior surface of the hinge pin barrel enclosure 21, while maintaining the triggered base block frontal face groove recessed surface 52 in vertical positional alignment, and also, in firm contact with a portion of the outer circumferential surface of the hinge pin barrel enclosure 21.

When the trigger mechanism driving means 190 of the semiautomatic hinge pin removal tool 10 is activated, the pry blade head block subassembly 110 proximal front section blade face surface 112, disc-beveled pry-wedge edge surface 115 slides into the narrow gap intersection region 32 between the hinge pin front sloped undershoulder 24 and hinge pin barrel enclosure top surface 31, the clamping top capture cap subassembly 160 with a horizontal top capture surface 162 and front vertical chisel pry face tanged surface 164, advances and capture engages both the top and the back sloping undershoulder surface of the hinge pin head 22 while the retainer positional ring subassembly 140 locks onto the top head and side circumferential area 23 of the front sloped undershoulder 24 of the hinge pin head 22, so that all cooperating hinge pin removal tool components are cooperatively acting together to forcibly push and thereby urge the hinge pin shaft 28 vertically upward for subsequent smooth removal of the hinge pin 30 from the hinge pin barrel enclosure 21.

A trigger mechanism driving means 190, such as generated by manual hand-squeezed lever action or a motorized force, is applied from the trigger to an indexing arm rod and then through the front first sister spur gear 64 to the drive gear shaft 62, and then to the second pinion drive gear 68, so as the fixed dual sister drive gears rotate fixed together on common sister gear shaft 62, the gear rack base bar 70 is forced vertically upward in vertical, parallel relationship with the housing base block frontal face 48 and the pry blade head block subassembly 110, thereby forcing vertically upward the hinge pin 30 for easy extraction and removal from its hinge pin barrel enclosure 21. After the semi-automated door hinge pin removal tool 10 has successfully removed the hinge pin 30 from the hinge pin barrel enclosure 21, the top capture cap subassembly 160 clip release means 168 is activated, whereupon the hinge pin head 22 is released from captivity, thus freeing the semi-automated hinge pin removal tool 10 for future use.

Although there has been described above a door hinge pin removal tool in accordance with the present invention for purposes of illustrating the manner in which the present invention may be used to advantage, it is to be understood that the invention is not limited thereto. Consequently, any and all variations and equivalent arrangements, which may occur to those skilled in the applicable art, are to be considered to be within the scope and spirit of the invention, as set forth in the claims that are appended hereto as part of this U.S. Patent application.

1. A semi-automated hinge pin removal tool which comprises:
a. a pistol-shaped, housing main assembly member having a triggered base block subassembly including an acceptance barrel, a handle, and a trigger;
b. a hinge pin head engaging assembly member disposed at an open end of said acceptance barrel and having a retaining positional ring subassembly, a pry blade head block subassembly, and a capture cap subassembly;
c. said pry blade head block subassembly being mounted for axial movement from said acceptance barrel open end, and said pry blade head block subassembly being responsive to actuation of said trigger for extending from said acceptance barrel open end and being adapted to forcibly being inserted into a narrow gap intersection region formed between a sloped undershoulder surface of a hinge pin head and the top horizontal surface of a hinge pin barrel enclosure into which the hinge pin is installed and is to be removed; and
d. means responsive to operation of said trigger for elevating said pry blade head block subassembly relative to said acceptance barrel to thereby cause the hinge pin to be urged out of said hinge pin barrel enclosure.

2. The semi-automated hinge pin removal tool as claimed in claim 1, wherein said means for elevating said pry blade head block subassembly include ratchet means installed in said housing main assembly, said ratchet means being operatively connected to said trigger.

3. The semi-automated hinge pin removal tool as claimed in claim 2, wherein said ratchet means include a rack gear, and a pinion gear in driving relationship with said rack gear.

4. The semi-automated hinge pin removal tool as claimed in claim 3, wherein one end region of said rack gear is connected to said pry blade head block subassembly for causing the elevation thereof when the rack gear is driven by said pinion gear.

5. The semi-automated hinge pin removal tool as claimed in claim 1, wherein said top capture cap subassembly of said hinge pin head engaging assembly has quick release means.

6. A semi-automated hinge pin removal tool assembly for removing a hinge pin from the hinge pin barrel enclosure of a door hinge assembly comprising:
a housing main assembly member having a triggered base block subassembly with a frontal face, a rearward face, opposing side faces, a top upper area, a bottom lower area, said triggered base block subassembly having an acceptance barrel groove recess along a frontal face vertical axis adapted to receive the hinge pin barrel enclosure of a door hinge assembly, a handle, and a trigger;
a hinge pin head engaging assembly member disposed at an open end of said acceptance barrel groove recess and having a retaining positional ring subassembly, a pry blade head block subassembly, and a top capture cap subassembly;
said pry blade head block subassembly being connected to said triggered base block subassembly having a horizontal reversible, forward and backward slideable, advanceable proximal front section blade face surface, a distal back section tail end with an upper top surface, and a lower bottom surface, said pry blade head block subassembly being slidably secured to the upper end of a vertically movable base bar undermember, and said pry blade head block subassembly having a proximal front section blade face surface being extendable outwardly from said triggered base block subassembly;
said proximal front section blade face surface being movable horizontally and adapted to be driven forward horizontally by a driving means applied from said triggered base block subassembly urging said pry blade head block subassembly horizontally forward to wedge said proximal front section blade face surface into the narrow space gap intersection region defined by the hinge pin head sloped undershoulder and the hinge pin barrel enclosure, top horizontal surface;
said retaining positional ring being secured to said triggered base block subassembly for positioning said semi-automated hinge pin removal tool in fixed relationship to said hinge pin barrel enclosure, said retaining positional ring having an inner diameter being bevel-faced downward and extending outward from and connected to at least one of said triggered base block surfaces, said retaining positional ring positionally adapted to slip engage the back sloped undershoulder surface of said hinge pin head to act in combination with said triggered base block subassembly, front acceptance barrel groove recess face being held securely against the hinge pin barrel enclosure housing to maintain close mating and securing contact with said pry blade head block subassembly, proximal front section blade face surface;
said top capture cap being adapted to move forward with said front section blade face surface to cooperatively pry engage the back sloped undershoulder surface of the hinge pin head, and to use and employ the narrow gap intersection region formed between said hinge pin barrel enclosure housing/ retaining positional ring and the sloped undershoulder surface of the hinge pin head to wedge-engage the forward vertical chisel pry face of said top capture cap to further clamp and tightly engage the back sloped undershoulder of the hinge pin head in such cooperatively wedged and secured contact relationship as to secure said trigger base block subassembly, said pry blade head block subassembly, said retaining positional ring subassembly, said top capture cap subassembly, and said hinge pin enclosure barrel together as an integrated unit for hinge pin removal; and
driving force means applied to said triggered base block subassembly, being applied first sequentially horizontally to said pry blade head subassembly, and then being applied secondly sequentially vertically upward to said pry blade head block subassembly along a vertical axis of said triggered base block subassembly to urge said pry blade head subassembly upward, and thereby transmit a large mechanical force to said pry blade head block subassembly, proximal front section blade face surface for engaging said narrow gap intersection region between the hinge pin head front sloped undershoulder and the hinge pin barrel enclosure, top surface to contain and exert a strongly, leveraged upward vertical pry-wedge force to smoothly extract the hinge pin from the hinge pin barrel enclosure of the door hinge assembly.

7. The semi-automated hinge pin removal assembly as claimed in claim 6, wherein said first applied sequentially horizontal drive force is transmitted by drive rod means adapted for reversibly advancing forward said pry blade head block subassembly.

8. The semi-automated hinge pin removal assembly as claimed in claim 7, wherein said second applied sequentially vertical drive force is transmitted through a gear train drive including, in combination, a pinion gear and a rack gear.

9. The semi-automated hinge pin removal assembly as claimed in claim 8, wherein said retainer positional ring subassembly internal diameter being at least partially circular and inner diameter disc-beveled.

10. The semi-automated hinge pin removal assembly as claimed in claim 9, wherein said proximal front section blade face surface is disc-beveled.

11. The semi-automated hinge pin removal assembly as claimed in claim 9, wherein said pry blade face block subassembly, proximal front section blade face is disc-beveled pry wedge edge surfaced.

12. The semi-automated hinge pin removal assembly as claimed in claim 6, wherein said top capture cap has clip release means.

13. The semi-automated hinge pin removal assembly as claimed in claim 6, wherein said top capture cap has at least one front vertical chisel pry face tanged surface adapted to engage the sloped under surface of the hinge pin head.

14. A semi-automated hinge pin removal tool for removing a hinge pin from the hinge pin barrel enclosure of a door hinge assembly comprising:
a housing main assembly having a triggered base block subassembly with a frontal face, opposing side faces, an upper top face, a lower bottom face, and a core cavity, said frontal face having a hinge acceptance barrel groove recess along a vertical axis adapted to receive the hinge pin barrel enclosure of a door hinge pin assembly;
a slideable pry blade head block subassembly having a horizontally reversible forward and backward movable and vertically upward movable, advanceable proximal front section blade face surface and distal back section tail end, said pry blade head block subassembly being slidably secured to the upper top end of a gear train rack gear base member, and said pry blade head block subassembly proximal front section blade face surface having a disc-beveled pry-wedge edge surface extending outwardly from said triggered base block subassembly;
said slideable pry blade head block, proximal front section blade face surface being slidably movable and adapted to be driven forward horizontally by driving means applied from said triggered base block subassembly and transmitted to a forward advanceable linkage arm rod adapted for urging said pry blade head block subassembly forward to wedge-engage the proximal front section blade face surface disc-beveled pry-wedge edge surface into the narrow space gap intersection region formed by and between the hinge pin head front sloped undershoulder and the hinge pin barrel enclosure horizontal upper surface, for said disc-beveled pry-wedge edge surface to engage and penetrate said narrow space gap intersection region;
said gear train adapted to being positionally fixed within said core cavity of said base block subassembly, said gear train having a rack gear base member, a first sister indexing drive gear and a second sister rack drive gear, said first indexing sister and said second sister rack drive gear, joined face to face, coupled together concentrically on a central drive shaft, said rack gear base member having a lower bottom end and an upper top end, said bottom end facing said base block lower bottom surface and said upper top surface facing said triggered base block upper top surface and lower bottom surface of said horizontally slideable and vertically movable pry blade head block subassembly;
said upper top end surface of said rack driving gear being slidably connected to said rack gear base bar upper top end and adapted for transmitting a vertical upward force to said pry blade head block subassembly, said horizontally reversibile forward and backward movable and vertically upward moveable, proximal front section blade face surface having a disc-beveled pry-wedge edge surface adapted to wedge and slip engage into the narrow gap intersection region between the sloped undershoulder surface of the pin head and the hinge pin enclosure barrel horizontal top surface;
a retaining positional ring subassembly for positioning said triggered base block subassembly in fixed relationship to the door hinge assembly, said retaining positional ring subassembly inner diameter being bevel-faced and extending outward from and connected to one of said triggered base block surfaces, said retaining positional ring subassembly positionally adapted to slip engage the back sloped undershoulder surface of said hinge pin head, and to act in combination with said base block subassembly frontal face acceptance barrel face groove recess surface being held securely against the hinge pin barrel enclosure to maintain close mating contact with said pry blade head block subassembly, proximal front section blade face surface;
a top capture cap being adapted to advance forward with said front section blade face surface to engage and capture the top and the sloped back undershoulder surface of the hinge pin head, and to use the narrow gap intersection region between said retaining positional ring subassembly and back sloped undershoulder surface of the hinge pin head to wedge-engage the forward vertical chisel pry face tang of the top capture cap subassembly to further clamp and tightly engage the sloped back undershoulder of the hinge pin head in such wedged mating contact relationship as to secure said triggered base block subassembly, said pry blade head block subassembly, said retaining positional ring subassembly, said top capture cap, subassembly, and hinge pin barrel enclosure securely engaged to function together as an integrated unit; and
trigger mechanical driving means being applied to said base block subassembly applied first horizontally to said pry head block subassembly, and then applied secondarily to said gear train drive to cause said drive gears to drive said rack gear base to move vertically upward so as to urge said pry blade head subassembly upward to thereby transmit a large mechanical force to said pry blade head block, pry wedge end face surface to pry engage and enlarge said narrow gap intersection region between said hinge pin head, front sloped undershoulder and said hinge pin barrel enclosure horizontal top surface and, to thereby exert a strong leveraged upward vertical pry-wedge force for smoothly extracting the hinge pin from its hinge pin barrel enclosure.

15. The semi-automated hinge pin removal tool as claimed in claim 9 wherein said core cavity being constructed internally between the top upper surface and the bottom lower surface of said trigger base block subassembly.

16. The semi-automated hinge pin removal tool as claimed in claim 9, wherein said retainer positional ring internal diameter is at least partially circular and internally disc-beveled.

17. The semi-automated hinge pin removal tool as claimed in claim 9, wherein said pry blade end face is disc-beveled.

18. The semi-automated hinge pin removal assembly as claimed in claim 9, wherein said pry face subassembly front blade end face is disc-beveled with a pry wedge edged surface.

19. The semi-automated hinge pin removal assembly as claimed in claim 9, wherein said top capture cap has at least one vertical downward, front chisel pry face suface.

20. The semi-automated hinge pin removal assembly as claimed in claim 9, wherein said top capture cap vertical downward front chisel pry face is tanged.
